(19) United States
(12) Patent Application Publication
(10) Pub. No.: US 2023/0422237 A1
(43) Pub. Date: Dec. 28, 2023

(54) Communication apparatus and methods for scheduling reception activity of the communication apparatus

(71) Applicant: MediaTek Singapore Pte. Ltd., Singapore (SG)

(72) Inventors: Yanyan Qi, Beijing (CN); Fei Xu, Beijing (CN); Jianwei Zhang, Beijing (CN); Mingjun Xu, Beijing (CN); Yaochao Liu, Beijing (CN); Nien-En Wu, Hsinchu City (TW); Jun Hu, Beijing (CN)

(73) Assignee: MediaTek Singapore Pte. Ltd., Singapore (SG)

(21) Appl. No.: 17/894,153

(22) Filed: Aug. 23, 2022

(30) Foreign Application Priority Data
Jun. 28, 2022 (CN) 202210745855.1

(51) Int. Cl. H04W 72/12; H04W 76/28; H04L 5/00

(52) U.S. Cl. CPC H04W 72/1263; H04W 76/28; H04L 5/0051

(57) ABSTRACT

A method for scheduling reception activity of a communication apparatus to receive wireless signals from a network device in a wireless network, comprising: collecting information regarding network and operation of the communication apparatus; determining a scenario of the communication apparatus according to the information regarding network and operation of the communication apparatus; determining one or more reception related parameters according to the scenario of the communication apparatus; and scheduling one or more reception activities in at least one Discontinuous Reception (DRX) off duration according to the one or more reception related parameters.

### BACKGROUND

The term “wireless” normally refers to an electrical or electronic operation, which is accomplished without the use of a “hard wired” connection. “Wireless communications” is the transfer of information over a distance without the use of electrical conductors or wires. The distances involved may be short (a few meters for television remote controls) or very long (thousands or even millions of kilometers for radio communications). The best-known example of wireless communications is the cellular telephone. Cellular telephones use radio waves to enable an operator to make phone calls to another party, from many locations worldwide. They can be used anywhere, as long as there is a cellular telephone site to house equipment that can transmit and receive signals, which are processed to transfer both voice and data to and from the cellular telephones.

Power saving is always an important issue in developing a wireless communication device. As the function of the cellular telephone (or named mobile station) or any wireless communication device becomes more powerful nowadays, the power consumption speed of the wireless communication device is getting faster. Various techniques can be leveraged within wireless communication systems to enhance power savings for wireless communication devices. For instance, discontinuous reception (DRX) can be employed, such that a wireless communication device can be permitted to forgo monitoring a control channel for a period of time. Thus, the wireless communication device can be in DRX mode (e.g., sleep) for a period of time and active mode (e.g., awake, monitoring the control channel, etc.) for a disparate period of time, and the power consumption for monitoring the control channel can be reduced.

However, the communication quality may degrade due to the forgoing of monitoring the control channel for the period of time. Therefore, an intelligent method for scheduling reception activity of a communication apparatus with reduced power consumption while maintaining the communication quality is highly required.

### SUMMARY

According to an embodiment of the invention, a communication apparatus comprises a radio transceiver and a processor. The radio transceiver transmits or receives wireless signals to or from a network device in a wireless network. The processor is coupled to the radio transceiver and the application processor and configured to perform operations comprising: collecting information regarding network and operation of the communication apparatus; determining a scenario of the communication apparatus according to the information regarding network and operation of the communication apparatus; determining one or more reception related parameters according to the scenario of the communication apparatus; and scheduling one or more reception activities in at least one Discontinuous Reception (DRX) off duration according to the one or more reception related parameters.

According to another embodiment of the invention, a method for scheduling reception activity of a communication apparatus to receive wireless signals from a network device in a wireless network, comprising: collecting information regarding network and operation of the communication apparatus; determining a scenario of the communication apparatus according to the information regarding network and operation of the communication apparatus; determining one or more reception related parameters according to the scenario of the communication apparatus; and scheduling one or more reception activities in at least one Discontinuous Reception (DRX) off duration according to the one or more reception related parameters.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows an exemplary block diagram of a communication apparatus according to an embodiment of the invention.

FIG. 2 shows an exemplary block diagram of a modem according to an embodiment of the invention.

FIG. 3 is a schematic diagram showing the discontinuous reception (DRX) configuration for a UE in RRC Connected state.

FIG. 4 is a flow chart of a method for scheduling reception activity of a communication apparatus according to an embodiment of the invention.

FIG. 5 is an exemplary flow chart showing more detailed operations of the scenario and parameter determinations as illustrated in Step S404 and Step S406 according to an embodiment of the invention.

FIG. 6 is a schematic diagram showing a final RS Scheduling Pattern when the cycle muting indicator Cycle_Muting_Ind is set to 1:4 according to an embodiment of the invention.

FIG. 7 is a schematic diagram showing the reception window selection for the reference signal to be scheduled in the following DRX off duration according to an embodiment of the invention.

### DETAILED DESCRIPTION

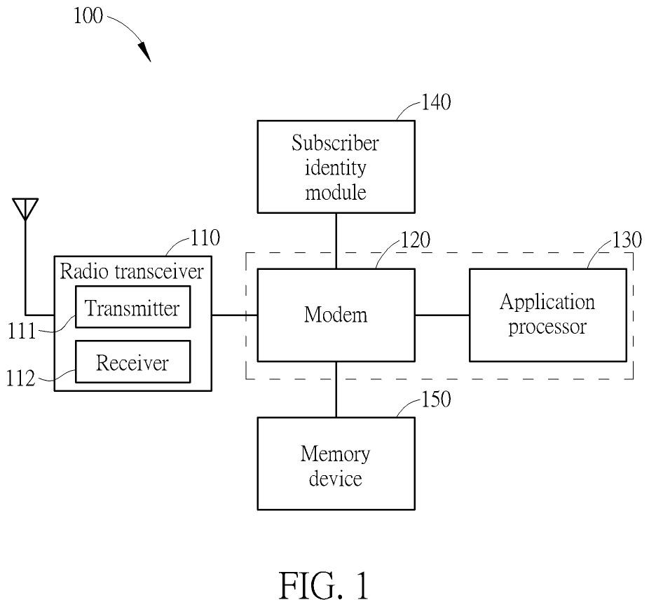

FIG. 1 shows an exemplary block diagram of a communication apparatus according to an embodiment of the invention. The communication apparatus 100 may be a portable electronic device, such as a Mobile Station (MS, which may be interchangeably referred to as User Equipment (UE)). The communication apparatus 100 may comprise at least an antenna module comprising at least one antenna, a radio transceiver 110, a modem 120, an application processor 130, a subscriber identity module 140, and a memory device 150. The radio transceiver 110 may be configured to transmit and/or receive wireless signals to and/or from a network device in a wireless network via the antenna module, so as to communicate with the network device via a communication link established between the communication apparatus 100 and the network device. The radio transceiver 110 may comprise a receiver 112 configured to receive wireless signals from the air interface and a transmitter 111 configured to transmit wireless signals to the air interface, and the radio transceiver 110 may be further configured to perform RF signal processing. For example, the receiver 112 may convert the received signals into intermediate frequency (IF) or baseband signals to be processed, or transmitter 111 may receive the IF or baseband signals from the modem 120 and convert the received signals into wireless signals to be transmitted to the network device in the wireless network or in an access network (e. g. a cellular network or a wireless local access network). According to embodiments of the invention, the network device may be a cell, a node B, an evolved node B (eNB), a next generation node B (gNB), a base station, a Mobility Management Entity (MME), an Access and Mobility Management Function (AMF) device, an access point (AP), etc., at the network side and communicating with the communication apparatus 100 by the wireless signals via the communication link.

The transmitter 111 and the receiver 112 of the radio transceiver 110 may comprise a plurality of hardware devices to perform radio frequency (RF) conversion and RF signal processing. For example, the transmitter 111 and/or the receiver 112 may comprise a power amplifier for amplifying the RF signals, a filter for filtering unwanted portions of the RF signals and/or a mixer for performing radio frequency conversion. According to an embodiment of the invention, the radio frequency may be, for example, the frequency of any specific frequency band for a LTE system, the frequency of any specific frequency band for a 5G NR system, or the frequency of any specific frequency band for a WiFi system, etc.

The modem 120 may be configured to handle corresponding communications protocol operations and processing the IF or baseband signals received from or to be transmitted to the radio transceiver 110. The application processor 130 is configured to run the operating system of the communication apparatus 100 and run application programs installed in the communication apparatus 100. In the embodiments of the invention, the modem 120 and the application processor 130 may be designed as discrete chips with some buses or hardware interfaces coupled therebetween, or they may be integrated into a combo chip (i.e., a system on chip (SoC)), and the invention should not be limited thereto.

The subscriber identity module 140 may be configured for a SIM, USIM, R-UIM or CSIM card, or the like. The memory device 150 may be coupled to the modem 120 and application processor 130 and may store system data or user data.

It should be noted that, in order to clarify the concept of the invention, FIG. 1 presents a simplified block diagram in which only the elements relevant to the invention are shown. For example, in some embodiments of the invention, the communication apparatus may further comprise some peripheral devices not shown in FIG. 1. In another example, in some embodiments of the invention, the communication apparatus may further comprise a central controller coupled to the modem 120 and the application processor 130. Therefore, the invention should not be limited to what is shown in FIG. 1.

In some embodiments of the invention, the communication apparatus is capable of supporting multiple radio access technologies (RATs) communications. In addition, those who are skilled in this technology can still make various alterations and modifications based on the descriptions given above to derive the communication apparatuses comprising multiple radio transceivers and/or multiple antenna modules for supporting multi-RAT wireless communications without departing from the scope and spirit of this invention. Therefore, in some embodiments of the invention, the communication apparatus may be designed to support a multi-card application, in either a single-standby or a multiple-standby manner, by making some alterations and modifications.

It should be further noted that the subscriber identity module 140 may be connected with hardware cards, or in some embodiments of the invention, there may be virtual cards, such as individual identifiers, numbers, addresses, or the like which are burned in the internal memory device of the corresponding modem and are capable of identifying the communication apparatus. Therefore, the invention should not be limited to what is shown in the figures.

It should be further noted that in some embodiments of the invention, the communication apparatus may further support multiple

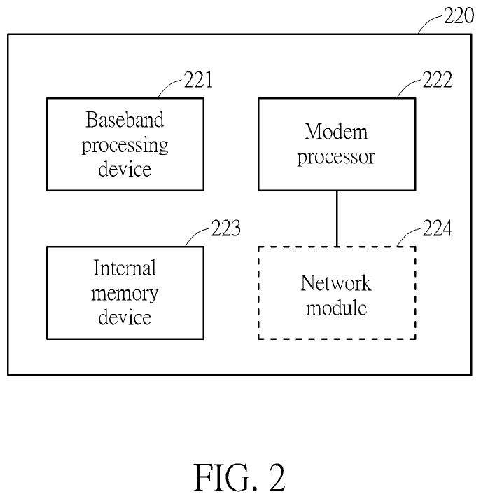

FIG. 2 shows an exemplary block diagram of a modem according to an embodiment of the invention. The modem 220 may be the modem 120 shown in FIG. 1 and may comprise at least a baseband processing device 221, a processor 222 (to discriminate from the “application processor” shown in FIG. 1, hereinafter named the “modem processor”), an internal memory device 223 and a network module 224. The baseband processing device 221 may receive the IF or baseband signals from the radio transceiver 110 and perform IF or baseband signal processing. For example, the baseband processing device 221 may convert the IF or baseband signals into a plurality of digital signals, and process the digital signals, and vice versa. The baseband processing device 221 may comprise a plurality of hardware devices to perform signal processing, such as an analog-to-digital converter for ADC conversion, a digital-to-analog converter for DAC conversion, an amplifier for gain adjustment, a modulator for signal modulation, a demodulator for signal demodulation, an encoder for signal encoding, a decoder for signal decoding, and so on.

According to an embodiment of the invention, the baseband processing device 221 may be designed to have the capability of handling the baseband signal processing operations for different RATs and processing the corresponding IF or baseband signals in compliance with the corresponding communications protocols, so as to support the multi-RAT wireless communications. According to another embodiment of the invention, the baseband processing device 221 may comprise a plurality of sub-units, each being designed to have the capability of handling the baseband signal processing operations of one or more specific RATs and processing the corresponding IF or baseband signals in compliance with the corresponding communications protocols, so as to support the multi-RAT wireless communications. Therefore, the invention should not be limited to any specific way of implementation.

The modem processor 222 may control the operations of the modem 220. According to an embodiment of the invention, the modem processor 222 may be arranged to execute the program codes of the corresponding software module of the modem 220. The modem processor 222 may maintain and execute the individual tasks, threads, and/or protocol stacks for different software modules. In an embodiment, a protocol stack may be implemented so as to respectively handle the radio activities of one RAT. However, it is also possible to implement more than one protocol stack to handle the radio activities of one RAT at the same time, or implement only one protocol stack to handle the radio activities of more than one RAT at the same time, and the invention should not be limited thereto.

The modem processor 222 may also read data from the subscriber identity card coupled to the modem, and write data to the subscriber identity card. The internal memory device 223 may store system data and user data for the modem 220. The modem processor 222 may also access the internal memory device 223.

The network module 224 provides Internet access services for the communication apparatus. It should be noted that, although the network module 224 shown in FIG. 2 is configured inside of the modem, the invention should not be limited thereto. In some embodiments of the invention, the communication apparatus may also comprise a network module configured outside of the modem, or the communication apparatus may also be coupled to an external network card for providing Internet access services. In some embodiments of the invention, the network module 224 may be a virtual network card, instead of a tangible card, that is created by the operating system of the communication apparatus 100. Therefore, the invention should not be limited to any specific implementation method.

It should be noted that, in order to clarify the concept of the invention, FIG. 2 presents simplified block diagrams in which only the elements relevant to the invention are shown. Therefore, the invention should not be limited to what is shown in FIG. 2.

It should be further noted that in some embodiments of the invention, the modem may also comprise more than one processor and/or more than one baseband processing device. For example, the modem may comprise multiple processors and/or multiple baseband processing devices for supporting multi-RAT operations. Therefore, the invention should not be limited to what is shown in FIG. 2.

It should be further noted that in some embodiments of the invention, the baseband processing device 221 and the modem processor 222 may be integrated into one processing unit, and the modem may comprise one or multiple such processing units, for supporting multi-RAT operations. Therefore, the invention should not be limited to what is shown in FIG. 2.

According to an embodiment of the invention, the modem processor 222 and the application processor 130 may comprise a plurality of logics, each, designed for handling one or more functionalities. The logics may be configured to execute the program codes of one or more software and/or firmware modules, thereby performing the corresponding operations. When performing the corresponding operations by executing the corresponding programs, the logics may be regarded as dedicated hardware devices or circuits, such as dedicated processor sub-units. Generally, the modem processor 222 may be configured to perform operations of relative lower protocol layers while the application processor 130 may be configured to perform operations of relative higher protocol layers.

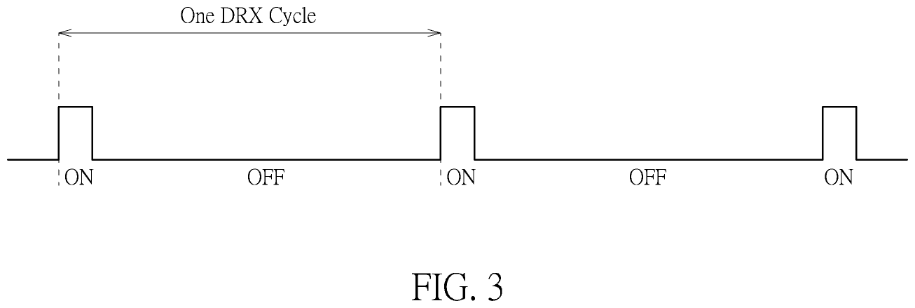

FIG. 3 is a schematic diagram showing the discontinuous reception (DRX) configuration for a User Equipment (UE) (e.g. the communication apparatus 100) in RRC_Connected state. The network device may configure, as an example, via a radio resource control (RRC) signaling, the length of a DRX cycle as well as the ON or OFF duration for the UE. The UE is required to monitor Physical Downlink Control Channel (PDCCH) in the DRX ON duration, and is not required to monitor the PDCCH and also not required to perform any transmission or reception activity in the DRX off duration. Sometimes, the UE may enter a “Sleep Mode” in the DRX off duration for power saving.

However, due to various measurement requirements, a conventional UE still needs to wake up during the “Sleep Mode” to perform some measurements, such as measurements of one or more reference signals, and these measurements indeed cause extra power consumption for the UE. To solve this problem, an intelligent method for scheduling reception activity of a communication apparatus with reduced power consumption while maintaining the communication quality is proposed.

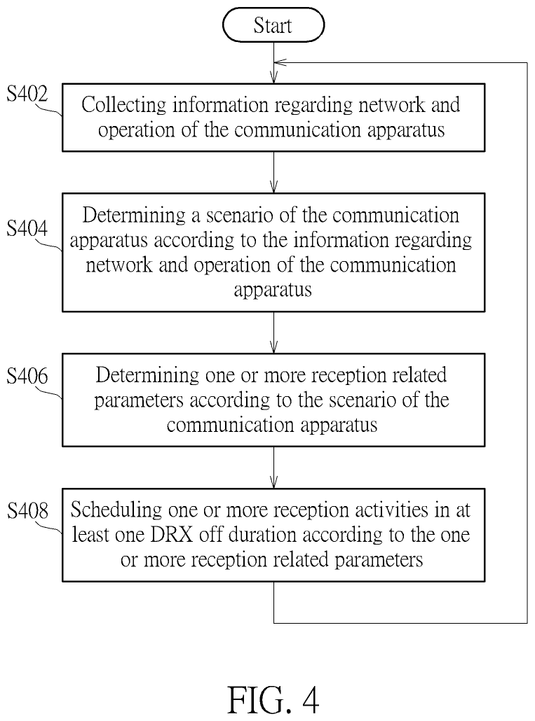

FIG. 4 is a flow chart of a method for scheduling reception activity of a communication apparatus for the communication apparatus to receive wireless signals from a network device in a wireless network in a more power-saving manner according to an embodiment of the invention. The method may comprise the following operations or steps performed by the modem processor 222:
Step S402: collecting information regarding network and operation of the communication apparatus.
Step S404: determining a scenario of the communication apparatus according to the information regarding network and operation of the communication apparatus.
Step S406: determining one or more reception related parameters according to the scenario of the communication apparatus.
Step S408: scheduling one or more reception activities in at least one DRX off duration according to the one or more reception related parameters.

According to an embodiment of the invention, when the modem processor 222 schedules one or more reception activities in at least one DRX off duration for receiving the reference signal (RS) according to the one or more reception related parameters determined in step S406, a final RS Scheduling Pattern may be generated and provided for the radio transceiver 110 to perform the one or more scheduled reception activities, so as to receive the corresponding RS at the corresponding time based on the final RS scheduling pattern. The modem processor 222 may then perform the corresponding measurements on the received RS.

According to an embodiment of the invention, the modem processor 222 may repeatedly perform the operations or steps illustrated in FIG. 4. That is, step S402 may be repeatedly performed for the modem processor 222 to collect the latest information for a subsequent parameter determination and reception activity scheduling. If there is any degradation in communication quality or performance as indicated in the latest collected information, it reveals that the previous parameter determination and reception scheduling may be improper and the modem processor 222 may readjust the reception related parameters in step S406 and reschedule the reception activities in step S408 based on the latest collected information and the corresponding scenario. In this manner, the reception related parameters and the scheduling of one or more reception activities may be dynamically or adaptively adjusted in real-time based on the latest collected information.

According to an embodiment of the invention, the information regarding network and operation of the communication apparatus may be collected based on at least one parameter of the communication apparatus 100, and the at least one parameter may be at least one of: a throughput (e.g. the uplink and/or downlink traffic loading), a gesture, an accelerator output, a Modulation and Coding Scheme (MCS), a Block Error Rate (BLER), a Signal to Noise Ratio (SNR) and mutual information.

In an embodiment of the invention, the throughput or the uplink and/or downlink traffic loading may be monitored or counted (or calculated) by either the modem processor 222 or the application processor 130, or both. When both the modem processor 222 and the application processor 130 have monitored, counted and/or calculated the throughput or the traffic loading, the statistic results may be averaged or weighted and then combined to obtain a final statistic result.

In an embodiment of the invention, the gesture of the communication apparatus 100 and the accelerator output may be obtained from the application processor 130. As an example, the communication apparatus 100 may be equipped with a gyroscope, an accelerometer, a pose sensor, a location sensor and/or an activity sensor, and those devices may be controlled by the application processor 130.

In an embodiment of the invention, the MCS may be configured by the network device in the downlink control information (DCI), and the modem processor 222 may count or calculate the BLER based on the error occurred in receiving signals from the physical downlink shared channel (PDSCH).

In an embodiment of the invention, the modem processor 222 may calculate the SNR for the measurement of the reference signal. As an example, the modem processor 222 may calculate the SNR for the Tracking Reference Signal (TRS), the Synchronization Signal/ Physical Broadcast Channel (PBCH) Block (SSB), Channel State Information Reference Signal (CSI-RS), PDCCH deModulation Reference Signal (dmrs), PDSCH dmrs, or the likes.

In an embodiment of the invention, the mutual information may be an indicator indicating the signal quality and may be obtained during the process when the modem processor 222 is performing channel estimation and PDSCH decoding.

In an embodiment of the invention, the collected information regarding network and operation of the communication apparatus may also comprise the RRC configuration information. As an example, the modem processor 222 may obtain the periodicity of the DRX cycle, a length of the ON/OFF duration of the DRX cycle, the position of the ON/OFF duration of the DRX cycle, the settings of the DRX related timers and the positions and configurations of the reference signals from the RRC configuration information.

According to an embodiment of the invention, the one or more reception related parameters may comprise a cycle muting indicator Cycle_Muting_Ind indicating a ratio of a number of unmuting DRX cycles to a number of configured DRX cycles. In the embodiments of the invention, when scheduling the one or more reception activities in step S408, the modem processor 222 may schedule one or more reception activities in a DRX off duration of an unmuting DRX cycle and not schedule any reception activity in a DRX off duration of a muting DRX cycle. As an example, when the cycle muting indicator Cycle_Muting_Ind is set to 1:4, it means that there is 1 unmuting DRX cycle among 4 configured DRX cycles. In other words, among 4 successive DRX cycles, there are 3 muting DRX cycles and 1 unmuting DRX cycle.

Note that in some embodiments of the invention, the cycle muting indicator Cycle_Muting_Ind may also be regarded as or may be converted to a down-sampling rate. As an example, when the cycle muting indicator Cycle_Muting_Ind is set to 1:4, the down-sampling rate is 4. That is, among 4 configured DRX cycles, only 1 DRX cycle will be unmuted in its DRX off duration and the rest 3 DRX cycles will be muted (i.e. no reception activities will be scheduled in their DRX off duration). Therefore, as compared to the conventional art in which the DRX off duration of all DRX cycles are practically unmuted and are scheduled with reception activities (for example, reception activities for neighbor cell measurement or channel estimation), based on the proposed method, the down-sampling rate for down-sampling the unmuting DRX cycles (i.e. the DRX cycles having the DRX off durations that cannot sleep and still have to wake up and perform reception activities for RS measurement) is increased from 1 (that is, no down-sampling) to 4.

According to an embodiment of the invention, the one or more reception related parameters may further comprise a reference signal muting indicator RS_Muting_Ind indicating a reception activity of which reference signal is to be scheduled in the DRX off duration of the unmuting DRX cycle. Note that the reference signal muting indicator RS_Muting_Ind also indicates the reception activity of which reference signal is not to be scheduled (that is, muted) in the DRX off duration of the unmuting DRX cycle.

As an example, the reference signal muting indicator RS_Muting_Ind may indicate the reception activities of both the SSB and TRS are to be scheduled in the DRX off duration of one or more subsequent unmuting DRX cycles for SSB measurements and TRS measurements, or only the reception activities of the SSB are to be scheduled in the DRX off duration of one or more subsequent unmuting DRX cycles for SSB measurements (thus, the reception activities of the TRS are muted in the one or more subsequent unmuting DRX cycles), or only the reception activities of the TRS are to be scheduled in the DRX off duration of one or more subsequent unmuting DRX cycles for TRS measurements (thus, the reception activities of the SSB are muted in the one or more subsequent unmuting DRX cycles), or the likes.

According to an embodiment of the invention, the one or more reception related parameters further comprise a reference signal window indicator RS_Win_Ind indicating which reception window of the reference signal to be scheduled is selected for scheduling the reception activity of the reference signal. Generally, the network device may transmit the reference signals for more than one time, thus creating a plurality of reception windows for each reference signal. When there are more than one reception window for receiving a predetermined reference signal in the subsequent unmuting DRX cycle, the modem processor 222 may select the one having a location that is closest to the DRX ON duration or select the one that is fully or partially overlapping the DRX ON duration, so as to further reduce the power consumption.

According to an embodiment of the invention, the modem processor 222 may be configured to determine the scenario of the communication apparatus 100 in two stages, for considering the status of the communication apparatus 100 from different aspects. In a first stage of scenario determination, the modem processor 222 may determine a motion status of the communication apparatus 100, and in a second stage of scenario determination, the modem processor 222 may determine a traffic loading of the communication apparatus 100.

In addition, in response to the scenarios individually determined in two stages, the modem processor 222 may determine a first cycle muting indicator based on the motion status of the communication apparatus 100 determined in the first stage of scenario determination, determine a second cycle muting indicator based on the traffic loading of the communication apparatus 100 determined in the second stage of scenario determination, and determine a final cycle muting indicator according to the first cycle muting indicator and the second cycle muting indicator.

In an embodiment of the invention, the modem processor 222 may directly take the strict one as the final cycle muting indicator. As an example, if the first cycle muting indicator is determined as 1:4 and the second cycle muting indicator is determined as 1:8, the modem processor 222 may directly take the strict one (e.g. the first cycle muting indicator having smaller down-sampling rate) as the final cycle muting indicator.

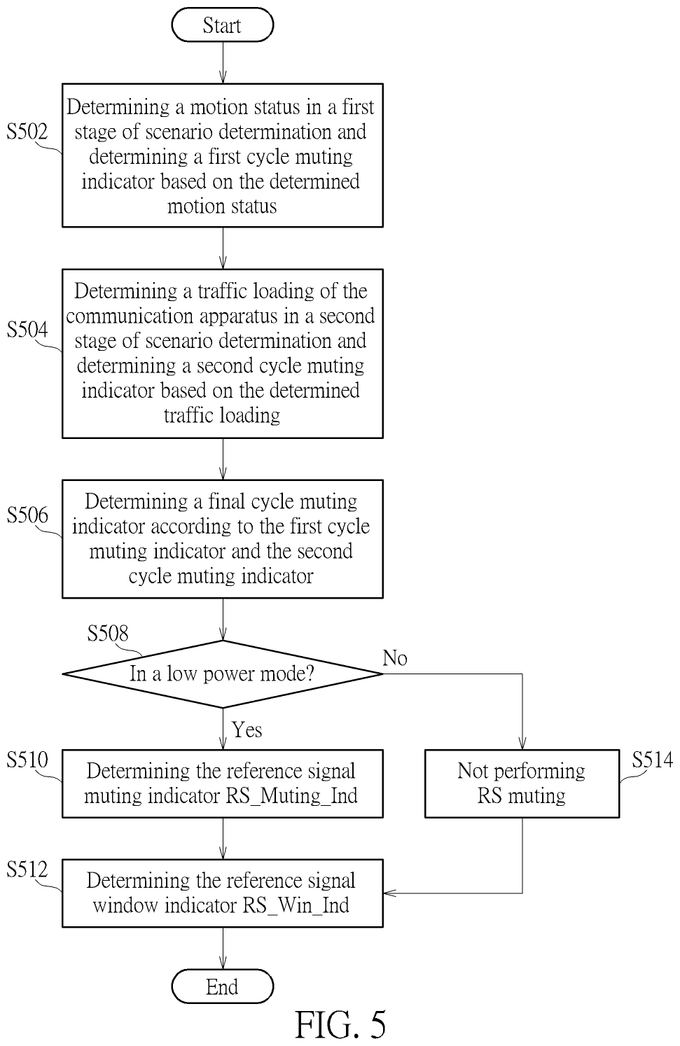

FIG. 5 is an exemplary flow chart showing more detailed operations of the scenario and parameter determinations as illustrated in Step S404 and Step S406 according to an embodiment of the invention. The method may comprise the following operations or steps performed by the modem processor 222:
Step S502: determining a motion status of the communication apparatus 100 in a first stage of scenario determination and determining a first cycle muting indicator based on the determined motion status. According to an embodiment of the invention, the modem processor 222 may determine the motion status based on a gesture, an accelerator output, or the detection or sensing result of the pose sensor, the location sensor and/or an activity sensor. In an embodiment of the invention, the motion status may comprise, as an example but not limited to, rotation, moving, non-static and static (or, quasi-static). According to an embodiment of the invention, when the communication apparatus 100 is determined in a rotation or moving status, the down-sampling rate for down-sampling the unmuting DRX cycles having the DRX off durations that cannot sleep and still have to wake up is preferably set to a smaller value. That is, for the rotation or moving status, the communication apparatus 100 is preferably to perform measurement more frequently, and thus the number of muting DRX cycle is preferably small. For example, the first cycle muting indicator may be set as 1:2, 1:3, or the likes, for the rotation or moving status. On the contrary, for the static or quasi-static status, the communication apparatus 100 may perform measurement less frequently for lower extra power consumption, and thus the down-sampling rate for down-sampling the unmuting DRX cycles may be set to a greater value. For example, the first cycle muting indicator may be set as 1:8, 1:10, or the likes, for the static or quasi-static status.
Step S504: determining a traffic loading of the communication apparatus 100 in a second stage of scenario determination and determining a second cycle muting indicator based on the determined traffic loading. According to an embodiment of the invention, the modem processor 222 may determine the traffic loading based on the uplink and/or downlink traffic loading, the throughput, the MCS, the uplink and/or downlink scheduling information, or the likes. The modem processor 222 may use one or more thresholds to determine whether the traffic loading of the communication apparatus 100 is light, medium or heavy. For the light loading scenario, the down-sampling rate for down-sampling the unmuting DRX cycles may be set to a greater value, for example, the second cycle muting indicator may be set as 1:8, 1:10, or the likes. For the medium loading scenario, the down-sampling rate for down-sampling the unmuting DRX cycles may be set to a smaller value, for example, the second cycle muting indicator may be set as 1:2, 1:3, or the likes. For the heavy loading scenario, the down-sampling of the unmuting DRX cycles to achieve lower extra power consumption may be stopped, and the second cycle muting indicator may be set as 1:1.

Note that in the embodiments of the invention, a maximum down-sampling rate (or a cycle muting indicator threshold) may be pre-determined for each motion status as well as each traffic loading scenario, and the modem processor 222 may determine a corresponding cycle muting indicator that is not greater than the corresponding maximum down-sampling in steps S502 and 5504.
Step S506: determining a final cycle muting indicator according to the first cycle muting indicator and the second cycle muting indicator. In an embodiment of the invention, the modem processor 222 may directly take the strict one as the final cycle muting indicator. As an example, if the first cycle muting indicator is determined as 1:8 and the second cycle muting indicator is determined as 1:2, the final cycle muting indicator may be set to 1:2. Note that in some embodiments of the invention, the modem processor 222 may also determine the final cycle muting indicator further according to a comprehensive consideration of the information regarding network and operation of the communication apparatus, such as the SNR, BLER, MI, MCS, or the likes. For example, the higher SNR or MI and/or the lower BLER, the higher down-sampling rate may be selected.
Step S508: determining whether the communication apparatus 100 is going to operate in a low power mode for lower extra power consumption. If the final cycle muting indicator is set to 1:1, it is determined that the communication apparatus 100 is not going to operate in a low power mode and then step S514 is performed. If the final cycle muting indicator is not set to 1:1, it is determined that the communication apparatus 100 is going to operate in a low power mode and then step S510 is performed.
Step S510: determining the reference signal muting indicator RS_Muting_Ind according to the final cycle muting indicator determined in step S506 and a comprehensive consideration of the information regarding network and operation of the communication apparatus, such as the SNR, BLER, MI, MCS, or the likes. The higher SNR or MI and/or the lower BLER, the more reception activities and/or the more reference signals may be muted (that is, will not be scheduled in the DRX off durations of the unmuting DRX cycle). As an example, the modem processor 222 may select the reference signal with higher SNR as the one to be scheduled in the DRX off duration of the unmuting DRX cycle. As another example, the modem processor 222 may select the reference signal with at least one reception window falls within the DRX off duration of the unmuting DRX cycle as the one to be scheduled. As yet another example, when the information regarding network and operation of the communication apparatus shows that communication quality or performance is poorer than a predetermined threshold, the modem processor 222 determine that no reference signal will be muted in the DRX off duration of the unmuting DRX cycle.
Step S512: determining the reference signal window indicator RS_Win_Ind according to the final cycle muting indicator determined in step S506 and a comprehensive consideration of the information regarding network and operation of the communication apparatus, such as the SNR, BLER, MI, MCS, or the likes. As previously described, the modem processor 222 may select the reception window whose location is closest to the DRX ON duration or select the reception window that is fully or partially overlapping the DRX ON duration, so as to reduce the power consumption.
Step S514: determining not to perform RS muting. That is, when the final cycle muting indicator is set to 1:1, there may be no muting DRX cycles and the modem processor 222 may schedule the reception activities of all reference signals that have to be monitored in the DRX off duration of the DRX cycles.

As previously described, the reception related parameters and the scheduling of one or more reception activities may be dynamically or adaptively adjusted in real-time based on the latest collected information. For example, when the latest collected information, such as a decreased SNR or an increased BLER, shows degradation in communication quality or performance, the modem processor 222 may decrease the down-sampling rate and/or determine not to perform RS muting, so as to perform measurement more frequently. On the contrary, when the latest collected information, such as an increased SNR or a decreased BLER, shows improvement in communication quality or performance, the modem processor 222 may increase the down-sampling rate and/or perform more RS muting, so as to perform measurement less frequently for reducing extra power consumption in the DRX off durations.

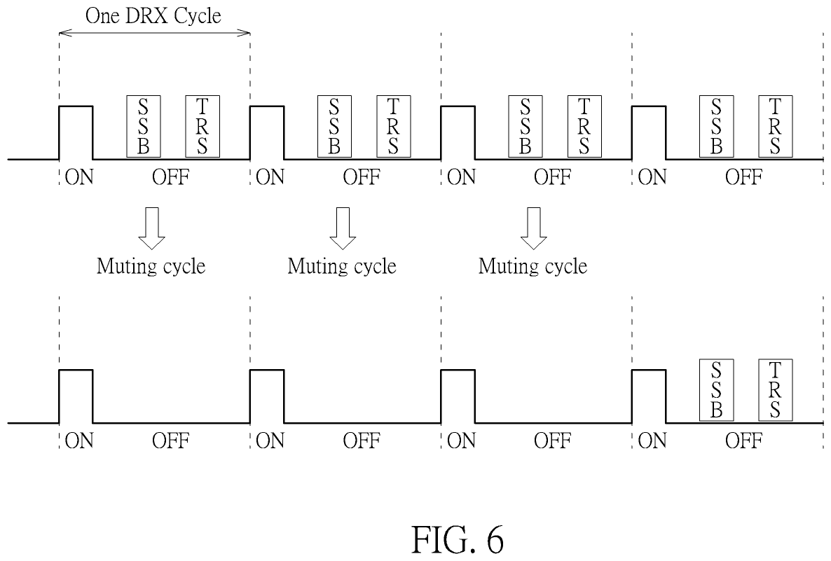

FIG. 6 is a schematic diagram showing a final RS Scheduling Pattern when the cycle muting indicator Cycle_Muting_Ind is set to 1:4 according to an embodiment of the invention. In this embodiment, there will be no extra power consumption in the DRX off durations of the first three DRX cycles, and the overall power consumption can be greatly reduced to, as an example, ¼, as compared to the conventional art in which the down-sampling rate is 1 (that is, no down-sampling).

In addition, in an embodiment of the invention, during the DRX on duration, the modem processor 222 may determine whether the communication apparatus 100 still has to wake up and perform reception activities for RS measurement in the following DRX off duration, and determine the RS Scheduling Pattern as discussed above when it is determined that the communication apparatus 100 has to wake up and perform reception activities for RS measurement in the following DRX off duration.

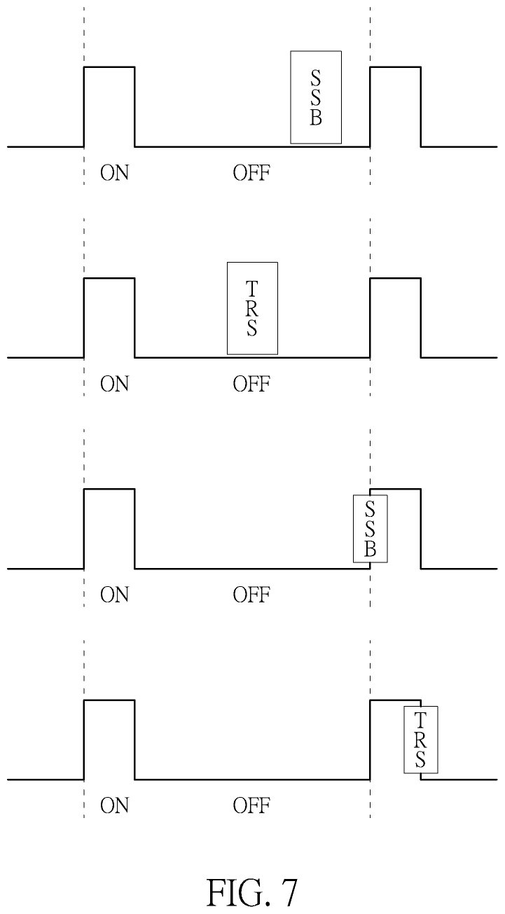

FIG. 7 is a schematic diagram showing the reception window selection for the reference signal to be scheduled in the following DRX off duration according to an embodiment of the invention. In the embodiments of the invention, the modem processor 222 may select the reception window for the reference signal to be scheduled in the current DRX off duration (such as the reception window of the SSB shown in the first row, or the reception window of the TRS shown in the second row), right before the next DRX on duration (such as the reception window of the SSB shown in the third row since it is partially overlapping the former portion of the next DRX ON duration), or right after the next DRX on duration (such as the reception window of the TRS shown in the fourth row since it is partially overlapping the later portion of the next DRX ON duration). According to some preferred embodiments, RS reception window is at least partially overlapped with DRX ON duration.

By applying the proposed method for smart scheduling reception activity of a communication apparatus in the DRX off duration, a result of low power consumption can be achieved while maintain good communication quality.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A communication apparatus, comprising:
a radio transceiver, transmitting or receiving wireless signals to or from a network device in a wireless network; and
a processor, coupled to the radio transceiver and configured to perform operations comprising:
collecting information regarding network and operation of the communication apparatus;
determining a scenario of the communication apparatus according to the information regarding network and operation of the communication apparatus;
determining one or more reception related parameters according to the scenario of the communication apparatus; and
scheduling one or more reception activities in at least one Discontinuous Reception (DRX) off duration according to the one or more reception related parameters.

2. The communication apparatus of claim 1, wherein the one or more reception related parameters comprise a cycle muting indicator indicating a ratio of a number of unmuting DRX cycles to a number of configured DRX cycles, and wherein when scheduling the one or more reception activities, the processor is further configured to perform operations comprising:
scheduling the one or more reception activities in a DRX off duration of a unmuting DRX cycle; and
not scheduling any reception activity in a DRX off duration of a muting DRX cycle.

3. The communication apparatus of claim 2, wherein the one or more reception related parameters further comprise a reference signal muting indicator indicating a reception activity of which reference signal is to be scheduled in the DRX off duration of the unmuting DRX cycle.

4. The communication apparatus of claim 3, wherein the one or more reception related parameters further comprise a reference signal window indicator indicating which reception window of the reference signal to be scheduled is selected for scheduling the reception activity of the reference signal.

5. The communication apparatus of claim 4, wherein the reception window is at least partially overlapped with a DRX ON duration.

6. The communication apparatus of claim 1, wherein the processor is configured to determine the scenario of the communication apparatus in two stages, and wherein when determining the scenario of the communication apparatus, the processor is further configured to perform operations comprising:
determining a motion status of the communication apparatus in a first stage of scenario determination; and
determining a traffic loading of the communication apparatus in a second stage of scenario determination.

7. The communication apparatus of claim 6, wherein the one or more reception related parameters comprise a cycle muting indicator indicating a ratio of a number of unmuting DRX cycles to a number of configured DRX cycles, and wherein when determining the one or more reception related parameters, the processor is further configured to perform operations comprising:
determining a first cycle muting indicator based on the motion status of the communication apparatus determined in the first stage of scenario determination;
determining a second cycle muting indicator based on the traffic loading of the communication apparatus determined in the second stage of scenario determination; and
determining a final cycle muting indicator according to the first cycle muting indicator and the second cycle muting indicator.

8. The communication apparatus of claim 6, wherein a cycle muting indicator threshold is pre-determined corresponding to each motion status and/or each traffic loading scenario.

9. The communication apparatus of claim 1, wherein the information regarding network and operation of the communication apparatus is collected based on at least one parameter of the communication apparatus, and the at least one parameter comprises a throughput, a gesture, an accelerator output, a Modulation and Coding Scheme (MCS), a Block Error Rate (BLER), a Signal to Noise Ratio and/or mutual information.

10. The communication apparatus of claim 1, wherein the processor is further configured to repeatedly perform the operations.

11. A method for scheduling reception activity of a communication apparatus to receive wireless signals from a network device in a wireless network, comprising:
collecting information regarding network and operation of the communication apparatus;
determining a scenario of the communication apparatus according to the information regarding network and operation of the communication apparatus;
determining one or more reception related parameters according to the scenario of the communication apparatus; and
scheduling one or more reception activities in at least one Discontinuous Reception (DRX) off duration according to the one or more reception related parameters.

12. The method of claim 11, wherein the one or more reception related parameters comprise a cycle muting indicator indicating a ratio of a number of unmuting DRX cycles to a number of configured DRX cycles, and wherein step of scheduling the one or more reception activities in at least one DRX off duration according to the one or more reception related parameters further comprises:
scheduling the one or more reception activities in a DRX off duration of a unmuting DRX cycle; and
not scheduling any reception activity in a DRX off duration of a muting DRX cycle.

13. The method of claim 12, wherein the one or more reception related parameters further comprise a reference signal muting indicator indicating a reception activity of which reference signal is to be scheduled in the DRX off duration of the unmuting DRX cycle.

14. The method of claim 13, wherein the one or more reception related parameters further comprise a reference signal window indicator indicating which reception window of the reference signal to be scheduled is selected for scheduling the reception activity of the reference signal.

15. The method of claim 14, wherein the reception window is at least partially overlapped with a DRX ON duration.

16. The method of claim 11, wherein the scenario of the communication apparatus is determined in two stages, and wherein step of determining the scenario of the communication apparatus according to the information regarding network and operation of the communication apparatus further comprises:
determining a motion status of the communication apparatus in a first stage of scenario determination; and
determining a traffic loading of the communication apparatus in a second stage of scenario determination.

17. The method of claim 16, wherein the one or more reception related parameters comprise a cycle muting indicator indicating a ratio of a number of unmuting DRX cycles to a number of configured DRX cycles, and wherein step of determining the one or more reception related parameters according to the scenario of the communication apparatus further comprises:
determining a first cycle muting indicator based on the motion status of the communication apparatus determined in the first stage of scenario determination;
determining a second cycle muting indicator based on the traffic loading of the communication apparatus determined in the second stage of scenario determination; and
determining a final cycle muting indicator according to the first cycle muting indicator and the second cycle muting indicator.

18. The method of claim 16, wherein a cycle muting indicator threshold is pre-determined corresponding to each motion status and/or each traffic loading scenario.

19. The method of claim 11, wherein the information regarding network and operation of the communication apparatus is collected based on at least one parameter of the communication apparatus, and the at least one parameter comprises a throughput, a gesture, an accelerator output, a Modulation and Coding Scheme (MCS), a Block Error Rate (BLER), a Signal to Noise Ratio and/or mutual information.

20. The method of claim 11, wherein the steps are repeatedly performed.
